(19) United States
(12) Patent Application Publication
(10) Pub. No.: US 2024/0420857 A1
(43) Pub. Date: Dec. 19, 2024

(54) AUTOMATED METHOD FOR DETERMINING CORE-LOADING PATTERNS FOR NUCLEAR REACTOR CORES

(71) Applicant: ELECTRICITE DE FRANCE, Paris (FR)

(72) Inventors: Jean-Yves LUCAS, VERRIERES LE BUISSON (FR); Mariya KROTOVA, MONTROUGE (FR); Julien HOLLEVILLE, GUYANCOURT (FR); Blandine BLOMME, PARIS (FR)

(73) Assignee: ELECTRICITE DE FRANCE, Paris (FR)

(21) Appl. No.: 18/716,273

(22) PCT Filed: Dec. 8, 2022
(86) PCT No.: PCT/EP2022/084997

§ 371 Date: Jun. 4, 2024

(30) Foreign Application Priority Data
Dec. 17, 2021 (FR) 2113896

(51) Int. Cl. G21D 3/00

(52) U.S. Cl. CPC G21D 3/002

(57) ABSTRACT

A computer-assisted method for determining an optimal core-loading pattern for a nuclear reactor core. Positions of nuclear fuel assemblies are tested to assign optimal positions and to load the reactor. The reactor core includes cells positioned symmetrically to axes of symmetry and a standard assembly for insertion into each cell. Standard assemblies are distributed by the number of previous production cycles. Groups of cell positions symmetric to the axes of symmetry are identified, and symmetric positions are counted. Families of standard assemblies having similar burnups are formed, wherein the standard assemblies correspond to positions in a group. The loading pattern of standard assemblies in initial positions is tested by numerical simulation, then the positions are swapped while maintaining the previously formed families of assemblies. The swapped positions loading pattern is tested by numerical simulation. This is repeated until at least one candidate pattern for loading the reactor is obtained.

### FIELD

This disclosure concerns a determination of core-loading patterns for nuclear reactor cores.

### BACKGROUND

It more particularly concerns the development of computing methods and tools applicable to nuclear reactors. The application concerned here relates to one of the first stages in a chain of core calculations for designing loading patterns.

Before each actual reloading of a nuclear power plant's reactor vessel with nuclear assemblies, the operator must carry out a set of studies intended to evaluate the safety and operation of the future reactor core, which impacts the actual restart of a nuclear plant.

To carry out these studies, the operator generally has access to a “core calculation chain”, integrating an application for reloading assemblies for a new nuclear production cycle. These applications, located at the start of the chain, allow designing the loading pattern for cores in operation which must comply with all safety criteria, as well as with a set of constraints referred to as “operating constraints”, which for example prohibit certain positions for certain assemblies.

Currently, engineers solve this complex combinatorial problem “by hand”, with dedicated applications.

There is therefore a need to have a tool capable of automatically designing these reloading patterns, taking into account in a configurable manner the correct safety criteria, the operating constraints, and the quality of the assemblies available in reserve. This category of assemblies, stored in pools, is called the “management reserve”. Management reserves are assemblies that generally have seen some use but are still capable of an additional operating cycle.

From an operator's point of view, there is a need for a tool capable of managing the constraints on the positioning of assemblies in the core.

### SUMMARY

This disclosure improves the situation.

A method assisted by computer means is proposed for determining an optimal core-loading pattern for a nuclear reactor core. In this method in particular, respective positions of nuclear fuel assemblies are tested by said computer means according to at least one criterion before assigning optimal positions to the assemblies and proceeding with loading the reactor. The reactor core comprises (without the fuel assemblies) a multiplicity of cells positioned symmetrically relative to a plurality of axes of symmetry, with standard assemblies each intended for insertion into a cell.

Standard assemblies for future loading are distributed into at least three categories, defined by the number of production cycles they have undergone within the nuclear reactor:
a first category of assemblies which have not been used in a previous production cycle and which have a burnup below a first threshold (new or equivalent assemblies),
a second category of assemblies which have been used in a previous production cycle and which have a burnup between the first threshold and a second threshold that is greater than the first threshold, and
a third category of assemblies which have been used in at least two previous production cycles and having a burnup above the second threshold.

The method comprises the following steps in particular:
identifying groups of cell positions which are symmetric relative to said axes of symmetry, and counting a number of symmetric positions in each group,
forming families of standard assemblies, the standard assemblies of a same family having at least similar burnups, said families each comprising a number of standard assemblies respectively corresponding to a number of positions in one of said groups (the term “respectively” meaning here that there is a bijection between the families of standard assemblies and the groups of positions, each family of assemblies and each group of positions being linked by the bijection respectively comprising the same number of elements),
choosing, from a database of valid template loading patterns, a template loading pattern for which the assembly burnups, by family, are closest to the burnups of the standard assemblies, by family, and, within the context of a numerical simulation, assigning to the standard assemblies respective initial positions corresponding to the positions of the assemblies in the chosen template pattern,
testing, by numerical simulation, the loading pattern composed of the standard assemblies at said initial positions, in relation to at least one predetermined criterion,
swapping positions of standard assemblies while retaining the previously formed families of assemblies, and testing, by numerical simulation, the loading pattern formed of the standard assemblies at said swapped positions, in relation to said predetermined criterion, and
repeating the swapping and testing step until at least one candidate pattern for loading the reactor is obtained, the candidate pattern being the one which best satisfies said predetermined criterion.

Recall here that the burnup (or burnup rate) is a fundamental quantity in characterizing a fuel assembly and in modeling the core calculations. It characterizes the energy produced by a fuel assembly during its fission. It is expressed in MWd/t, the ratio of the total energy produced to the mass in metric tons of initial heavy metal loaded. By knowing the burnup, we can quickly calculate the energy by multiplying the specific power by the number of previous calendar days of operation, for example. As a rough and general rule, the higher the burnup of a set of assemblies, the lower the power generated in comparison to a set of new assemblies.

Here, in forming a family of assemblies, “similar burnups” is understood to mean assembly burnups where the values do not deviate (in absolute value) from each other (or from an average per family) by more than a few percentage points for example. The criterion of “similar burnups” may not be the only criterion for grouping assemblies by family. The assemblies of a same family may also be designed according to a same technology and/or may comprise the same type of fuel, and/or other criteria.

Similarly, the above term “template loading pattern for which the burnups of assemblies, by family, are closest to the burnups . . . ” is understood to mean the selection in a database of a template pattern in which the burnup values are “closest” to those of the standard assemblies, for example by choosing the template pattern which minimizes a distance calculation between the sum of the squares of differences of the average burnup values, by family, of the template pattern and of the standard assemblies.

The aforementioned first and second “thresholds” are also understood to mean thresholds which simply delimit ranges of burnups (for example between 0 and 200 MWd/t, then between 200 and 17,000 MWd/t, then between 17,000 and 33,000 MWd/t or more, etc.), these ranges being most often defined by the number of production cycles already undergone by these standard assemblies.

“Testing by numerical simulation” is understood to mean neutronics calculations (often in 3D) of the core operating with standard assemblies in the positions tested, in the absence or in the presence of neutron-absorbing control rod clusters that quench the fission nuclear reaction, and from which one can extract, in particular by the configuration of the control rod clusters, at least the values for the shutdown margin and the fuel rod powers or “hot spot factors Fxy and Fxy,g”, respectively in the absence and in the presence of control rod clusters (these parameters being explained below with reference to FIGS. 50 and 51). Moreover, the aforementioned “criterion” to be satisfied may be based on a combination of these parameters, and in particular the intent in general is not to exceed the limit values of these parameters for the selection of a candidate core.

“Swapping positions of standard assemblies” is understood to mean both a swapping across assemblies of a same family (“intra-family” swaps) and exchanges of positions between all respective assemblies of two different families (“inter-family” swaps), these different families having the same number of members. In particular, the members of a family remain in the same family after swapping (and are not split up).

Such an embodiment within the meaning of this disclosure, with automated generation of patterns which are then tested by said computer means, by swaps or by intermixing with other patterns as will be seen in one exemplary embodiment presented below, results in patterns of unexpected quality for a person skilled in the art, and sometimes in a counterintuitive manner.

Such computerized generation makes it possible to produce quality patterns which are rapidly convergent (in a few tens of minutes at most) for satisfying the aforementioned criterion (denoted “CPE” and defined below).

Typically, the swaps may be carried out randomly (or pseudo-randomly because they are still controlled by said computer means), while remaining in accordance with predetermined rules (in particular such as the manner in which the positions of assemblies can be swapped).

In one embodiment (for most cores, typically in pressurized water reactors), said plurality of axes of symmetry comprises four axes of symmetry of the core, which pass through the center of the core and comprise two axes, one vertical and the other horizontal, and two other axes having a respective slope of 45 degrees and 135 degrees relative to a horizontal line (all these axes intersecting at the center of the core pattern). We then consider groups of N positions of cells located on said axes of symmetry, and groups of M positions of cells not located on said axes of symmetry (typically with M>N for the cores of pressurized water reactors). For example, for a core of 157 assemblies, we have M=8 and N=4.

In one embodiment, the aforementioned method may include, in the context of said numerical simulation:
placing an assembly, chosen among said standard assemblies, in a central position, and
placing the assemblies of said families around the central assembly, in groups of positions that are symmetric relative to the plurality of axes of symmetry, the assemblies positioned in a same group of positions being members of a same family of assemblies (and therefore having similar burnups).

Typically the central assembly may be chosen based on its burnup. In general, it may be the one that has the highest burnup and is able to undergo an additional cycle in the core without going beyond a prescribed burnup. The central assembly is not in a family and is therefore not affected by any swapping. Furthermore, it may be preferred to place new or equivalent assemblies at the periphery of the core in order to smooth out (or homogenize) the radial power distribution, due to their high reactivity, meaning their high capacity to generate nuclear fission. This also allows compensating for neutron leakage at the edge of the vessel. As illustrated in FIG. 50, in general the intent is to avoid local peaks in power P (dotted curves) and to smooth the power distribution as much as possible (solid curves).

It will thus be understood that these core preliminary arrangements may initially be given by said template pattern, for example.

Among the predefined swapping rules, swaps within a same family modify each assembly position of the family.

Thus, during intra-family swaps, all assemblies are moved by swaps within the family.

Such an implementation is illustrated as an example in FIG. 19.

Among the predefined swapping rules, in order to test swaps between families (inter-family), the method may comprise:
swapping the positions of standard assemblies between two different families having the same number of members, and testing, by numerical simulation, the loading pattern composed of the standard assemblies at said swapped positions, in relation to said predetermined criterion.

Such an implementation is illustrated as an example in FIG. 20.

In an implementation for the creation of “intermixed patterns” as mentioned above, the swapping and testing step may be:
carried out in a predetermined number of iterations, until a first candidate pattern is identified, then
repeated for a predetermined number of iterations, until a second candidate pattern is identified, the method further comprising at least one step of testing an intermixed pattern that combines the first and second patterns.

This step may of course be successively repeated, with two, then three, four, etc. pairs of candidate patterns, which allows gradually converging towards an ideal pattern, as illustrated in FIG. 21 described below, this ideal pattern satisfying said predetermined criterion.

In one embodiment, the construction of an intermixed pattern may be carried out as follows:
the positions of a subset of the families of assemblies of the first candidate pattern are kept, and the remaining families of assemblies are:
assigned to positions which coincide with the positions of these same families in the second pattern, if these positions are still available in the intermixed pattern, or
(otherwise) assigned to other groups of available positions, the number of members of said other groups being equal to the number of family members that remain to be placed.

Such an implementation is illustrated in FIG. 19.

In this case, families of four assemblies are always assigned to sets each composed of four positions (locations referred to above as “cells”) and/or families of eight assemblies are assigned to sets each composed of eight positions.

To further satisfy said predefined swapping rules, the assemblies generally include a face which is facing a predetermined observation point, and after swapping, the swapped assemblies still have this face facing the observation point (for example the north face of an assembly is still facing north after the swapping).

As for verifying that said predetermined criterion has been achieved, a numerical simulation may be carried out by neutronics calculations for each core pattern tested, under conditions with and without insertion of neutron-absorbing control rod clusters to quench the chain reaction, in order to estimate values specific to the core pattern tested, these values in particular comprising hot spot factors without clusters Fxy(pattern) and with clusters Fxy,g(pattern), as well as a shutdown margin Margin(pattern).

These estimated values may be compared to limit values in the calculation of a core-loading pattern evaluation expression, denoted CPE, and a candidate pattern may then be selected, among the possible patterns, which has the smallest evaluation expression CPE, thus satisfying said predetermined criterion.

In one exemplary embodiment, the evaluation expression CPE of a pattern is given by:

$$EPC = C \times max ( {Margin}_{lim} - Margin ( pattern ) ; 0 ) \text{} + ( \frac{{Margin}_{lim}}{{Fxy}_{lim}} ) \times max ( Fxy ( pattern ) - {Fxy}_{lim} ; 0 ) + {Margin}_{lim} \times {\sum }_{g} ( \frac{1}{{Fxy}_{lim} , g} \times max ( Fxy , g ( pattern ) - {Fxy}_{lim} , g ; 0 ) )$$

where:
   Marginₗᵢₘ is a shutdown margin limit value,
   Fxyₗᵢₘ,g is a hotspot limit value in the presence of control rod clusters,
   Fxyₗᵢₘ is a hotspot limit value in the absence of control rod clusters,
   C is a positive real coefficient, and
   Σ_{g} represents the sum of terms over a set of control rod clusters, for which the expression of a term for a given cluster g is:

$$( \frac{1}{{Fxy}_{lim} , g} \times max ( Fxy , g ( pattern ) - {Fxy}_{lim} , g ; 0 ) ) .$$

For example, in the evaluation expression CPE, the two terms:

$$( \frac{{Margin}_{lim}}{{Fxy}_{lim}} ) \times max ( Fxy ( pattern ) - {Fxy}_{lim} ; 0 )$$

$$and$$

$${Margin}_{lim} \times {\sum }_{g} ( \frac{1}{{Fxy}_{lim} , g} \times max ( Fry , g ( pattern ) - {Fxy}_{lim} , g ; 0 ) )$$

may be of the same order of magnitude, and the coefficient C may then initially be chosen so that the term C×max(Marginₗᵢₘ−Margin(pattern);0) is also of the same order of magnitude as one of the two aforementioned terms.

Typically, coefficient C may be between 0.5 and 1 (its value, for example, being 0.75).

Alternatively, coefficient C may be between 1 and 10 for example.

By implementing the above method, a core pattern thus obtained by the method can typically be distinguished from a “conventional” configuration of the prior art, in which the assemblies of the first category are located in a first peripheral zone of the core, the assemblies of the second category in a second intermediate zone of the core, and the assemblies of the third category in a third central zone. In a core obtained by implementing the above method, these assemblies can be more “intermixed” than in a conventional configuration, for example.

This disclosure also relates to a computer program comprising instructions for implementing the above method, when these instructions are executed by a processor. According to another aspect, a non-transitory computer-readable storage medium is provided, on which such a program is stored.

This disclosure also relates to a computing device comprising at least one processor for implementing the above method.

FIG. 52 illustrates an exemplary embodiment of such a device DEV, typically comprising a memory MEM capable of storing at least the instructions of a computer program of the aforementioned type and a processor PROC cooperating with the memory MEM in order to execute these instructions. The device DEV may further comprise an input interface IN with which the processor PROC cooperates in order to receive, for example, data relating to the assemblies (total number, burnup, template pattern data, etc.), and an output interface OUT with which the processor PROC cooperates in order to deliver, for example, the data of a candidate pattern.

### BRIEF DESCRIPTION OF THE DRAWINGS

Other features, details, and advantages will become apparent upon reading the detailed description below, and upon analyzing the appended drawings, in which:

FIG. 1 shows a fuel assembly of a reactor core in one exemplary embodiment.

FIG. 2 shows a section plan of a core having 157 assemblies in one exemplary embodiment.

FIG. 3 shows two calculation modules which take part in a method according to one embodiment of this disclosure: a module MOD1 for constructing patterns according to predefined rules (in particular core swapping and intermixing rules) and a module MOD2 for evaluating the pattern, thus constructed by module MOD1, according to said criterion CPE.

FIG. 4 to FIG. 8 show possible intra-family swaps for a family of four members.

FIG. 9 to FIG. 15 show possible intra-family swaps for a family of eight members.

FIG. 16 shows a possible exemplary implementation of a swapping between two families (inter-family swaps) having four members each (swapping of two families 4 placed at positions of symmetry 4).

FIG. 17 shows a possible exemplary implementation of a swapping between two families (inter-family swaps) having eight members each (swapping of two families 8 placed at positions of symmetry 8).

FIG. 18 shows an example of intermixing two parent patterns to generate a child pattern, according to one embodiment.

FIG. 19 shows a concrete example of an intra-family swapping according to one embodiment.

FIG. 20 shows a concrete example of an interfamily swapping according to one embodiment.

FIG. 21 shows the performances achieved in terms of convergence towards an optimum core pattern, while satisfying said criterion CPE, according to one concrete exemplary implementation (reactor 1 of the Dampierre power plant (France) for cycle 36).

FIG. 22 is a schematic flowchart of the method presented above, according to one exemplary embodiment.

FIG. 23 to FIG. 33 illustrate possible positions for families of four assemblies in a core having 157 assemblies.

FIG. 34 to FIG. 47 illustrate possible positions for families of eight assemblies in a core having 157 assemblies.

FIG. 48 shows a pattern for a core having 193 assemblies, produced by implementing the method.

FIG. 49 shows a pattern for a core having 205 assemblies, produced by implementing the method.

FIG. 50 schematically illustrates a radial power layer generated by a core in the absence of any control rod cluster, the layer being homogeneous (solid curve), or inhomogeneous (dotted curve) encouraging the presence of a hot spot PC (factor Fxy mentioned above).

FIG. 51 schematically illustrates a radial power layer generated by a core, here in the presence of control rod clusters g, the layer being homogeneous (solid curve), or inhomogeneous (dotted curve) encouraging the presence of a hot spot PC in the presence of clusters (factor Fxy,g mentioned above).

FIG. 52 schematically illustrates a device for implementing the above method, in one exemplary embodiment.

### DETAILED DESCRIPTION

This disclosure proposes a novel tool which improves the current situation, due to an approach according to a method which reduces the speeds of creating reloading patterns while designing cores which are optimized from a safety and operational point of view.

As presented above, this disclosure proposes a method using swaps of assemblies within families, or exchanges between families of assemblies in groups of positions having the same number of elements.

Below, a description is given of three specific steps which implement the swapping of assemblies in the positions of a nuclear reactor core, in order to reach a configuration for which the neutronic characteristics are within a predefined safety zone.

However, before describing the above method in detail, it is important to define a few fuel core concepts.

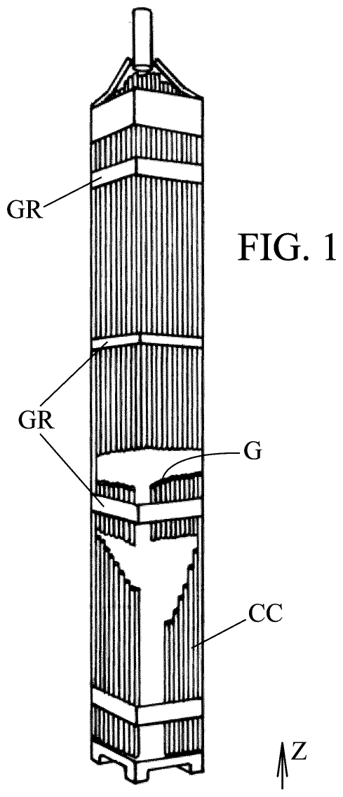

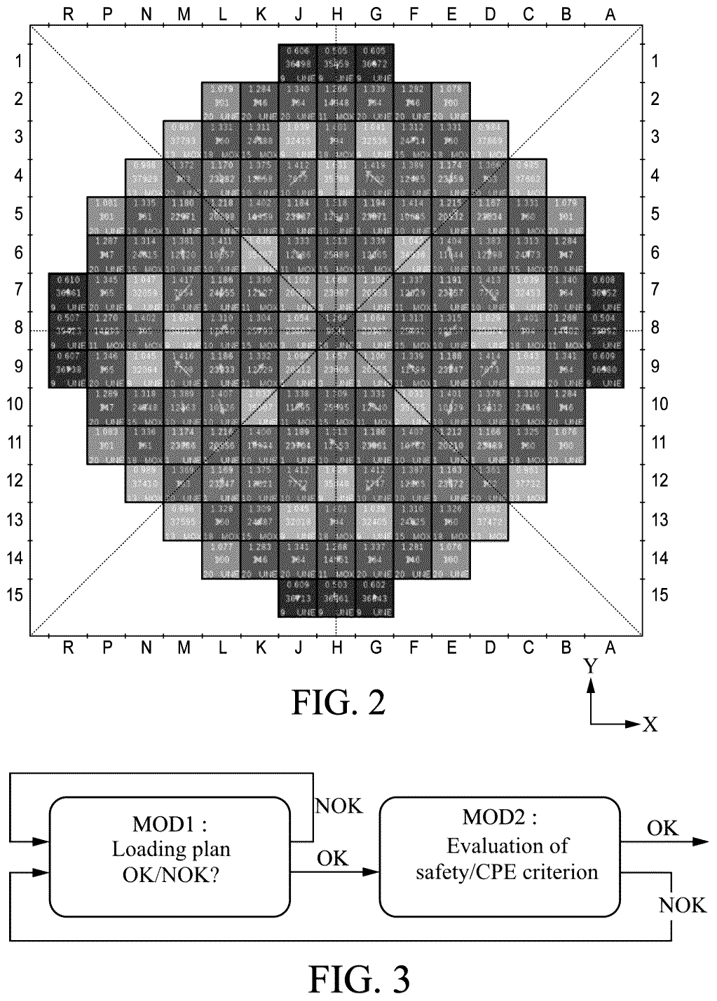

With reference to FIG. 1, in each assembly of a reactor core, tubes CC (called “fuel rods”) are assembled together, in particular using retaining grids GR. An assembly is the basic unit of fuel present in a nuclear reactor core, and the core is composed of a plurality of assemblies incorrectly referred to as “fuel assemblies”. Passages are also provided in at least a portion of the assemblies to allow the insertion of one or more control rod clusters G in order to quench the nuclear fission reaction as needed. Within each fuel rod, a plurality of fuel pellets are threaded into a cladding. The fuel pellets are, for example, made of uranium dioxide UO₂. The assembly in FIG. 1 is shown relative to the height axis z. The core itself, composed up of a plurality of assemblies such as the one illustrated in FIG. 1, is shown as an example in FIG. 2, in a section view within plane x,y.

Four axes of symmetry intersecting the center of the core pattern can be seen in particular in FIG. 2, one parallel to the x axis and one parallel to the y axis, and two axes respectively inclined by 45° and 135° relative to the x axis. The symmetry of the assemblies can be observed relative to each of these axes, particularly in terms of the respective values of the burnup or simply “burnup”.

One can see in FIG. 2 the symmetry of the positions of the assemblies having similar burnups. For example, the assemblies at H2 and H14 (symmetrical relative to the horizontal axis) have respective burnups of 14548 and 14561 (values appearing in the second row of each box in FIG. 1). One can also see that the assemblies at J3 and G3 (symmetrical relative to the vertical axis) have respective burnups of 32415 and 32536. One can also note that their respective symmetries C9 and C7 relative to the axis at 45° have similar burnups, which are 32262 and 32453. One can note that it is the same for their other symmetries N7, N9 and J13, G13. All these assemblies J3, G3, C7, C9, N7, N9, J13 and G13 then have burnups of between approximately 32000 and 32500, and are therefore very close relative to the burnups of the other assemblies. These assemblies J3, G3, C7, C9, N7, N9, J13 and G13 constitute a family which here occupies a group of positions which are symmetric relative to all the axes. They are eight in number, per group of symmetric positions, of a core composed of 157 assemblies in the example illustrated in FIG. 2. This number of groups of symmetric positions may be greater in a core having a greater number of assemblies.

To return to the example of assemblies at H2 and in H14 having respective burnups of 14548 and 14561, their symmetries in the same family are P8 and B8 and those burnups are 14599 and 14482. Again, one can see that these burnups are very similar for assemblies thus occupying a group of four positions which are symmetric relative to all the axes. This group in fact comprises only four position members, and not eight members as above, because these positions are themselves located on axes of symmetry.

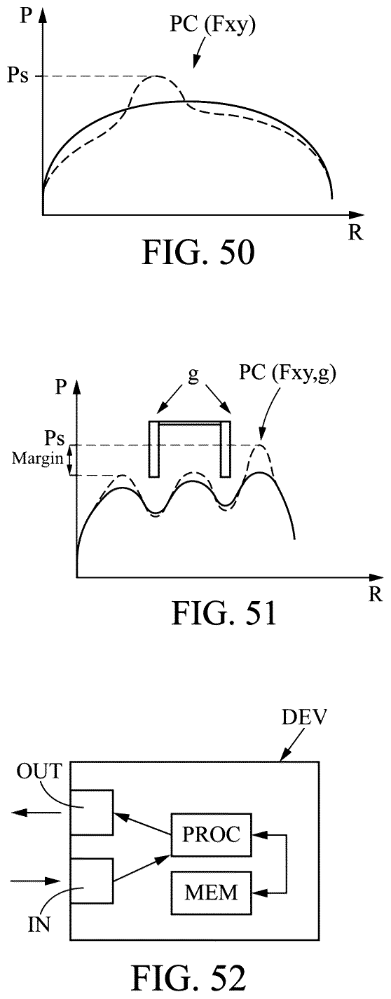

One can also note in FIG. 2 that, in addition to the assemblies at R7, R8, R9, J1, H1, G1, A7, A8, A9, J15, H15, G15 which have high burnups, in order to protect the vessel housing the core, the periphery of the core preferably comprises new assemblies which have low burnups at P5 to P11, L14-E14, B11-B5, E2-L2, likely to make these assemblies very reactive in a neutron flux. However, these assemblies, placed in these peripheral positions which correspond to areas with low neutron flux due to their leakage to outside the core, will be less neutron-productive, therefore will produce a lower power than the average for the assemblies. Here again, such an arrangement makes it possible to “smooth” (or homogenize) the radial power distribution as illustrated in FIG. 50.

Recall that, in general, the desire is to avoid local peaks in power and to smooth the power distribution as much as possible. Typically, avoidance of hot spots (factor F_{x,y} explained below) is also desired.

An explanation of the “shutdown margin” principle is given below.

The operator is provided with two main means for controlling the nuclear reaction in the reactor core.

A first means consists of adjusting the concentration of boron in the water of the primary circuit, boron having the property of absorbing the neutrons produced by the nuclear fission reaction. Boron dilution is then understood to mean the operation consisting of injecting water into the primary circuit in order to reduce the boron concentration, and thus encourage an increase in the neutron flux. Conversely, boration is understood to mean the addition of boron to the water of the primary circuit to encourage boron concentration and therefore reduce the neutron flux.

A second means consists of inserting the control rod clusters (reference G in FIG. 1) into the core or removing them. These control rod clusters, which are grouped, contain neutron-absorbing materials. Their position at a given height in the core allows more or less reactivity in the reactor core; the reactivity expressed in pcm (per hundred thousand, 10-5) is the quantity which measures a relative increase in the neutron flux induced by a control means (movement of the control rod clusters, variation in the boron concentration, etc.).

During normal operation, the position of certain clusters is regulated by a computer according to a reactor power setpoint. However, it is necessary to keep certain clusters at a sufficient height, fixed by the technical operating specifications, so that dropping them into the core can effectively quench the nuclear fission reaction in the event of an automatic shutdown of the reactor. This height allows maximizing the anti-reactivity which will be introduced in case of necessity. This arrangement makes it possible to guarantee a “shutdown margin” sufficient to allow automatic shutdown of the reactor.

Referring again to FIG. 2, a “loading pattern” corresponds to the definition of a reload (an inventory of fuel assemblies) coupled to a matrix (defining the arrangement of these assemblies in the vessel).

The number of assemblies per type of nuclear reactor core is predetermined.

For example, in the case of assemblies having a square cross-section, the following arithmetic properties are met:
including the central assembly, the total number A of assemblies is always odd for any reactor, and
For reasons of “four-way” or “eight-way” symmetry as mentioned above, and to be able to ensure a minimum subdivision by three of the core during fuel replacement, A-1 is an integer divisible by 3 and 4.

Towards the end of an operating cycle N of a nuclear plant, the operator must anticipate the next operating cycle N+1 and have a loading pattern for cycle N+1. The industrial challenge is to minimize, at the end of cycle N, the temporary shutdown period known as “plant shutdown” for any maintenance of equipment and/or the unloading/reloading of nuclear fuel. Each day of downtime corresponds to a real loss of income for the operator. As soon as the plant shutdown phase begins, all the fuel assemblies from cycle N are unloaded from the vessel to a storage pool, called a “spent fuel pool” near the reactor building. The assemblies of the upcoming cycle N+1 are transferred from a spent fuel pool to the reactor building pool. Used assemblies not intended for further use, meaning not to be reloaded in the upcoming cycle, remain in the spent fuel pool for several years before removal for reprocessing. Assemblies that can still be reused in upcoming loading patterns for the plant expand the management reserve and are also stored in the spent fuel pool. To clarify these concepts and the orders of magnitude, such assemblies are the ones which have an approximate burnup within the following ranges: [8000; 14500] MWd/t, [20000; 25000], and [32000; 35000], etc., in the example of FIG. 2, while the “new” assemblies have a burnup of close to 100 MWd/t for example.

It should be noted that the above number of burnup ranges depends on the number of partitions in how the nuclear fuel is replaced. In the above example this is a partitioning by thirds, hence three ranges of burnups, without counting new or equivalent assemblies. For “fourth of a core” partitioning, four ranges of burnups would be observed. This is not a rule but an observation that results from core management.

Completely used up assemblies are temporarily stored before being removed for reprocessing.

At this time, fuel assembly loading may then begin. The assemblies are physically positioned at the position specified by the loading pattern.

For the actual design of the loading pattern, the technology of pressurized water reactors requires cores to be reloaded with new fuel assemblies according to a known periodicity. The type of fuel (uranium, plutonium, etc.), the enrichment of the pellets with fissile material (U, Pu) in the rods of the fuel rod assemblies, and the partitioning of the replenished portion, dictate the maximum natural cycle length that is achievable.

For example, for a 900 MWe PWR (“pressurized water reactor”) type of reactor, the number of assemblies A equals 157 and there are the following options, considering that A-1 assemblies are being partitioned:
partitioning by thirds means that 52 assemblies will be reloaded,
partitioning by fourths means that 40 assemblies will be reloaded, which in actuality results in the following partition: 3×40+36=156

Thus, at identical enrichment and identical loaded material, a “fourth of a core” cycle will be shorter than a “third of a core” cycle, because the first provides less reactivity than the second.

A strategy related to plant availability favors long cycles of 14 to 18 months or even more, leading to combining a third of a core partitioning and high uranium enrichment, at more than 4% for example, within the limits of the acceptability criteria previously approved by the nuclear regulatory authorities, including the performance of the fuel assemblies, the shutdown margins, and various operating envelope criteria (in particular the radial power layer generated).

Currently, the search for loading patterns is carried out manually by operating engineers.

“Manually” is understood to mean the initial positioning of assemblies A in a first step, although this step may be automated by imitation based on knowledge of loading patterns from previous cycles and consisting of reducing the differences in burnups for an assembly occupying a given “Battleship”-style position. Such a “Battleship”-identified loading pattern is of the type illustrated in FIG. 2.

In a second step, after evaluating the loading pattern established in this manner, the engineer modifies the location of certain families of assemblies in order to correct effects which cause the acceptability criteria to fall outside admissible safety and operating zones. The new pattern in turn is evaluated by neutronics calculations, and this is repeated until compliance with the abovementioned criteria is achieved. The obtained pattern is then the final pattern, on the basis of which the unloading/loading operations can actually be carried out.

This approach follows a set of compromises aimed at satisfying safety criteria and economic criteria while taking into account possible operating contingencies.

As a general rule, the desire is to place new assemblies more at the periphery of the reactor (fixed position according to management) to minimize radial power peaks (denoted Fxy) from the rods of the fuel assemblies by flattening the radial power layer, as illustrated by the solid curve in FIG. 50. The total power of a rod being defined, and normalized to 1, the “hot spot” factor Fxy is the maximum power of such a rod which must not exceed a limit value (for example Fxy=1.44, which means 44% more power than the average power of 1 due to the normalization). For example, the threshold Ps in FIG. 50 can be 1.44 and the inhomogeneous dotted curve is likely to exceed this limit at point PC.

Next, possible symmetries in the placement of the assemblies are looked for while limiting the hot spot factors (by setting an admissible limit Fxyₘₐₓ).

The same compromises are also looked for with the performance of the core achieved in the presence of control rod clusters, as illustrated in FIG. 51. In particular, in the presence of control rod clusters g, their insertion must be sufficiently effective to quench the nuclear fission reaction in the core, beyond or at a shutdown margin (denoted “Margin” in FIG. 51). Furthermore, it is also desired to further limit the hot spots in the presence of clusters g, denoted “Fxy, g” in FIG. 51 (appearing on the dotted curve).

Loading pattern optimization requires experience in order to propose solutions quickly on complex patterns. Indeed, finding an optimized pattern corresponds to a combinatorial problem of searching for a hundred patterns among a colossal number of possible matrices. This number is obtained by circular swaps between families and between members within each family. Typically, based for example on a core with 193 predetermined assemblies comprising 12 families of 4 assemblies, 18 families of 8 assemblies, in theory it is possible to place them in approximately 3 1030 matrices, the central assembly being fixed (with 3 1030˜12!×4!×18!×8!).

The resolution of this problem is not unique. Indeed, several patterns may favorably meet the safety requirements of the nuclear plant.

However, such an approach is tedious, and this disclosure proposes a particular use of computer resources, as explained below.

More particularly, it proposes carrying out a search for patterns using a numerical simulator linking two modules which are intended to quickly evaluate the criteria for the candidate loading pattern and to modify it. The first module, for constructing a loading pattern, is coupled with a second module for evaluating the safety and operational criteria for the pattern found. This is a process which can therefore be planned in two stages carried out by two modules MOD1, MOD2, as schematically shown in FIG. 3. The first module MOD1 proposes a “correct” core pattern (initially coming from a database of template patterns but with possible swaps according to predetermined swapping rules), and the second module MOD2 offers an evaluation in particular by digital neutronics calculations of the quality of the core thus constructed, in relation to a criterion referred to as “CPE” below (for “core pattern evaluation”).

The method may be iterated a plurality of times, the candidate core pattern retained being the one which best satisfies said criterion CPE (i.e. the one which minimizes it as presented in the example below).

Based on the characteristics calculated for a given core pattern by the neutronics calculation means of module MOD2, using the following function a value is determined for which the unit is pcm (per hundred thousand), yielding the Core Pattern Evaluation “CPE”:

$$EPC = 0.75 \times max ( {Margin}_{lim} - Margin ( pattern ) ; 0 ) \text{} + ( \frac{{Margin}_{lim}}{{Fxy}_{lim}} ) \times max ( Fxy ( pattern ) - {Fxy}_{lim} ; 0 ) + {Margin}_{lim} \times {\sum }_{g} ( \frac{1}{{Fxy}_{lim} , g} \times max ( Fxy , g ( pattern ) - {Fxy}_{lim} , g ; 0 ) ) ,$$

where by construction, CPE is greater than 0 or best of all equal to 0.

In fact, we are trying to minimize this function to reach the value of 0. As the component terms of the formula are positive, this means that in such case they are each zero, and therefore that each of the related criteria would be satisfied.

For example, for a 900 Mwe PWR type of reactor:
the shutdown margin limit value Marginₗᵢₘ is set at 1800 pcm,
the hot spot limit value Fxyₗᵢₘ is set at 1.44,
the hot spot limit values in the presence of control rod clusters Fxyₗᵢₘ,g correspond to the limit radial power peaks when clusters g are inserted into the core (per group of clusters or combinations of groups of clusters): the values are between 1.44 and 1.8 with reference to the current specifications set by the regulatory authorities in France; these values may vary from one country to another, depending in particular on the type of nuclear reactor core.

The values of Margin(pattern), Fxy(pattern) and Fxy,g(pattern) are calculated for a given core pattern by a neutronics calculation code which is, more precisely, a nuclear reactor physics code for which the main principles are now presented.

The term “nuclear reactor physics code” applies to software capable of calculating the three-dimensional distribution of power (in Watts) in a nuclear reactor core, based on structural data (geometry, chemical composition, composition of heavy nuclei, etc.). To do this, the software must be able, for example in 3D geometry, to:
calculate the temperature distribution of the coolant in the reactor core, the coolant being the fluid which carries away the heat produced by nuclear fission. This calculation is carried out by a module of the code referred to as the “thermohydraulic module”;
calculate the temperature distribution of the nuclear fuel. This calculation is carried out by a module of the code referred to as the “thermal module” or the “thermomechanical module” if mechanical aspects are also processed (for example the pellet-cladding interaction);
calculate the distribution of the neutron flux from which power is derived, using a module referred to as the “neutronic module”.

It is the coupled interaction of the above three modules which makes it possible to calculate the power in 3D in the reactor core.

The neutronics modify the coolant temperatures, the coolant temperature modifies the fuel temperatures. Temperatures of the moderator and fuel modify the neutronics. Indeed, fission (nuclear physics) is caused by an interaction of a heavy nucleus with neutrons (managed by the neutronic module), said fission producing heat which propagates in matter (managed by the thermal module), the latter transmitting its heat to the water (the coolant), which transports the heat by its increase in temperature (managed by the thermohydraulic module) and therefore modifies the temperature of the fuel.

Phenomena of counter-reactions are then observed. The coolant water also being the moderator by which the neutrons are slowed to facilitate fission, its temperature variation will modify its density and therefore the neutron slowdown, which therefore impacts future fission generation. At the same time, a change in fuel temperature increases neutron absorption reactions, particularly in Uranium 238, which modifies the neutronics.

Here, neutronics is the central branch in the physics of nuclear reactors because it governs the generation of said phenomena. It allows characterizing the neutron population distributed spatially and temporally according to an energy spectrum which will depend on the interaction with matter. These interactions are absorption (fissile, fertile, and sterile), diffusion, reflection, neutron leakage. To this must be added a kinetic component linked to the actual production of neutrons by fission, divided into prompt neutrons and delayed neutrons. The latter, which are in the minority and appear several seconds after the prompt neutrons, are essential to the control of a nuclear reactor. Other phenomena such as poisoning by xenon, a fission product, will also modify the neutronics.

Thus, the aforementioned physical phenomena which occur within a nuclear reactor are of great complexity, which requires calling upon physics calculation codes for cores of the so-called “COCCINELLE” type with which the Applicant is equipped.

One will understand the need for several iterations in order to evaluate the whole at equilibrium. Once convergence is achieved, the reactor physics code can produce results necessary for the operation and safety of the reactor:
location of the hot spot (Fxy),
“intelligent” distribution of power,
calculated responses from various core instruments,
control and stability of the reactor as a function of time,
irradiation of nuclear fuels (evaluation of burnups), etc.

The most conventional use of a reactor physics code lies in calculating the loading pattern, namely the optimal arrangement of the nuclear fuels which satisfies the numerous safety criteria (efficiency of the control rods or “clusters” above), hot spot (Fxy), flattening of the power layer, shutdown margin, etc.).

The COCCINELLE calculation code, the official code for the calculation chain currently in use in the French fleet of electricity-generating reactors, falls within the class of “reactor physics codes”. It comprises:
a 1D axial thermohydraulic module in the channel containing the water coolant;
a 1D radial thermal module in the cylindrical fuel rod;
a 3D neutronics module in neutron diffusion theory.

Neutron diffusion is a theoretical model widely used throughout the world for processing a simplified form of the Boltzmann equation which governs the behavior of neutrons in matter. Descriptions of the theoretical models used in COCCINELLE, far too complex to be detailed here, can be found in references in French (“La physique des réacteurs nucléaires, 3^{ème} édition”, author Serge Marguet, ISBN 978-2-7430-1105-5, published by Lavoisier) and in English “The physics of nuclear reactors”, author Serge Marguet, ISBN 978-3-319-59558-7, published by Springer).

Other, older reference works present the fundamental principles of the physics of nuclear reactors such as the “Traité de Neutronique” by Jean Bussac and Paul Reuss, published by HERMANN, ISBN 2-705-6011-9—second edition, 1985.

In the following, the method according to this disclosure is described for 900 MWe PWR-type cores comprising 157 fuel assemblies, but in a non-limiting manner because in principle the same method may be applied to all other cores, such as the 1300 MWe PWR comprising 193 assemblies, the 1450 Mwe PWR comprising 205 assemblies, and the “EPR” reactor which is a 1650 MWe pressurized water reactor comprising 241 assemblies.

The desire is to position 157 assemblies in the 157 positions (or “cells”) of a nuclear reactor core in such a way that the neutronic criteria determined by the calculation chain are below a threshold limit (hot spot factors without control rod clusters Fxy or with clusters g: Fxy,g) or above a threshold limit (shutdown margin Margin). These various criteria are combined in an evaluation function, defined above, which gives a numerical value to each core pattern (denoted CPE for “Core Pattern Evaluation”).

As a general rule, it is well known that it is preferable to position the assemblies so that the burnup substantially decreases starting from the center of the core. This is a general principle that the skilled person tries to follow during operations carried out “manually” as explained above. The method according to this disclosure, based in particular on random swaps, does not follow this approach, although it appears that the patterns found by the method according to this disclosure substantially comply with this principle. However, this method is different from the non-automated manual approach.

As indicated above, the method comprises three steps:
Step 1: partitioning the assemblies according to their respective burnups in order to form families (or “categories” in the definition of the method given above);
Step 2: selecting, from a database, a template pattern having the closest assembly burnups to those partitioned in step 1, and evaluating the CPE (by numerical simulation) of a core composed of the assemblies partitioned in step 1 and positioned in the assembly positions of the template pattern that have the closest burnups;
Step 3: considering groups of positions that are symmetric relative to axes of symmetry of the core and numerically simulating the effect of swaps of assemblies according to predefined rules (swaps within a same group and/or between groups, the assembly face always remaining facing a given observation point), then evaluating the CPE (by numerical simulation) of a core for which the assemblies are thus swapped; this step 3 may be iterated several times to test whether the CPE decreases compared to previous configurations. If such is the case, a candidate core configuration may thus be determined for the next cycle (the one with the lowest CPE).

We now detail each of these steps.

In step 1, we rely on an example of core management called “third of a core”, for a 900 MWe PWR-type reactor comprising 157 assemblies.

At the end of operating cycle N, the 157 assemblies are composed for example of:
52 assemblies that have irradiated about 10,000 MWd/t (i.e. 1 cycle): these assemblies are kept and reloaded in cycle N+1 for a second cycle,
52 assemblies that have irradiated about 25,000 MWd/t (i.e. 2 cycles): these assemblies are kept and reloaded in cycle N+1 for a third cycle,
52 assemblies that have irradiated about 33,000 MWd/t (i.e. 3 cycles): these assemblies are not kept and they are stored in a pool for later reprocessing,
1 assembly that has irradiated about 40,000 MWd/t (at least 4 cycles), the central assembly, which is also not kept: it is stored in a pool for later reprocessing.

For the next operating cycle N+1, at the start of the cycle 157 assemblies are selected:
52 new assemblies, having a burnup of 0 MWd/t (or residual, close to 0 and typically less than 200),
52 assemblies which have irradiated about 10,000 MWd/t (coming from previous cycles, see above),
52 assemblies which have irradiated about 25,000 MWd/t (coming from previous cycles, see above), and
1 assembly which has irradiated about 33,000 MWd/t (coming from the pool for previous cycles).

On these bases, the above 157 assemblies selected for cycle N+1 are classified into families defined as follows:
families of four assemblies, having similar burnups in a same family,
families of eight assemblies, having similar burnups in a same family, and
a family of one assembly, generally the most irradiated assembly as given in the above example.

“Neighboring burnups” is understood to mean burnups where the absolute value of their mutual differences are below a predefined threshold (1000 MWd/t for example).

In the following and somewhat imprecisely, we will designate these families comprising four assemblies, eight assemblies, or one assembly, respectively as “family 4”, “family 8”, and “family 1”.

The families of assemblies thus formed by such partitioning have, for a given family, similar burnup (BU) values, meaning the differences are for example about 1000 MWd/t (or less by a few percent typically), and also have identical technological characteristics (type of fuel, or other characteristics). In the following, these families are called “families of the future core pattern”.

The “loading” refers to all of the 157 fuel assemblies which, once positioned in the reactor vessel, will form what we call the “core” of the nuclear reactor.

Step 2 of identifying a pattern in a database containing numerous template loading patterns which come from different nuclear reactors (and not just the one currently being reloaded) is described below.

The database contains a set of patterns, some of them having the same characteristics as the one to be constructed for the present core for cycle N+1, which comprises, according to the example introduced in step 1, patterns formed of 157 assemblies partitioned into three batches of 52 assemblies and one central assembly.

Among these patterns, the comparison with the patterns in the database identifies the one hereinafter called the “template pattern”, for which the assembly burnups are closest to the burnups of the assemblies predefined in the previous step 1 and selected for cycle N+1 and for which the respective positions in the core are to be determined.

For this purpose, a “burnup distance” is determined between assemblies of the template pattern and those of the future core pattern. The distances between families of the same species are determined, meaning between families 4 on the one hand, and between families 8 on the other hand.

One embodiment may consist of comparing the average of the burnups of a first family 4 included in the loading constructed in step 1, with the average burnup of all the families 4 of the template pattern, and to match it to the family of the template pattern having the closest average.

Next, a comparison may be made between the average of the burnups of a second family 4 included in the loading constructed in step 1, and the average burnup of all the families 4 of the pattern, excluding the one that has already been matched. The method continues until all families 4 of the future core pattern have been matched with one and only one family 4 in the template pattern.

The same sub-steps are carried out in the same order as for families 4, but this time with families 8 of the future pattern and families 8 of the template pattern.

At the end of the two above sub-steps, all families in the future pattern are each matched with one and only one family in the template pattern. The sum of the squares of the differences between the average burnups of these matched families is then calculated. The final value is an indicator of the “distance” between these two sets of families. The definition of this indicator is not limiting, and it may for example be defined as the sum of the absolute values, therefore positive, of the differences between the average burnups of the matched families. The method is repeated over all template patterns. At the end of these iterations, each template pattern is associated with a distance to the families in the future core pattern.

The template pattern offering the minimum distance indicator is then selected. This is then the reference template pattern for constructing the pattern for the future cycle.

Once this template pattern has been selected, each family of the future pattern is placed in the same position of symmetry as the one occupied by the family in the reference template pattern with which it was matched during the previous processes.

The core pattern thus constructed is thus an initial core pattern (which must then undergo the swaps of step 3 described in detail below). One may note that the position of the central assembly located at H8 in the pattern in FIG. 2 is imposed and it does not undergo the aforementioned swaps.

Step 3 is described below.

In the core having 157 assemblies considered in this example, there are eleven positions of symmetry 4 (numbered from 1 to 11) and 14 positions of symmetry 8 (numbered from 12 to 25), plus one central position.

With reference to FIG. 2, these positions of symmetry 4 are the positions placed on diagonals R1-A15 and R15-A1 and medians H1-H15 and R8-A8. The central assembly is excluded.

All other positions are positions of symmetry 8: none of the assemblies of the concerned families 8 are positioned on a diagonal or on a median as defined above.

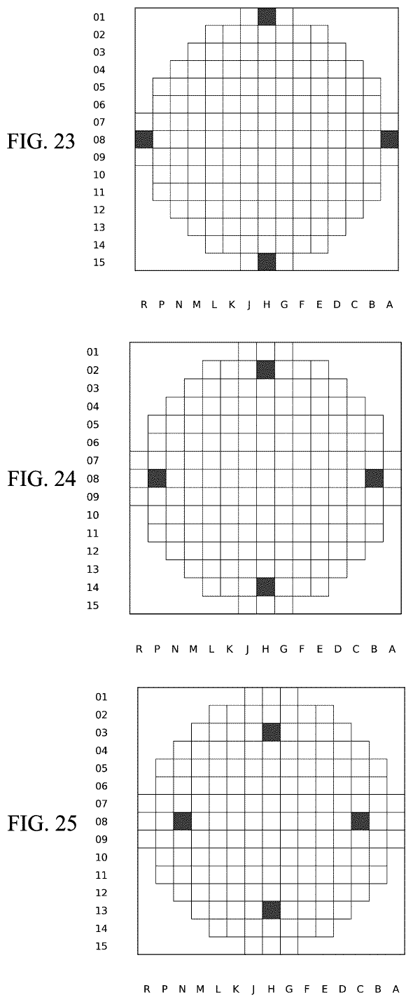

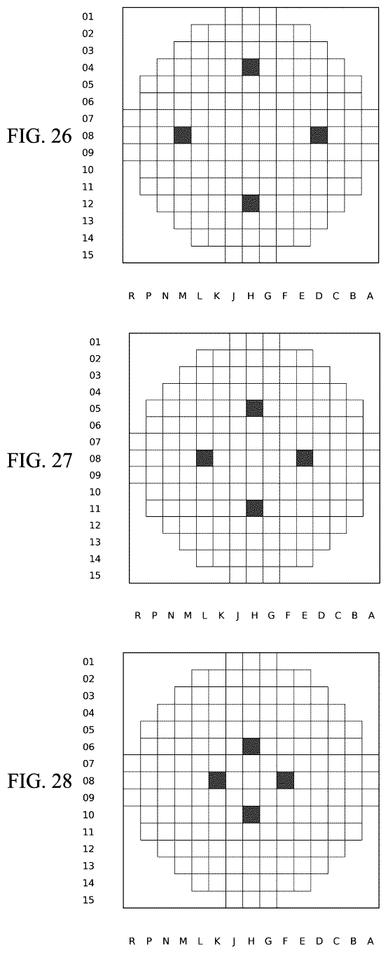

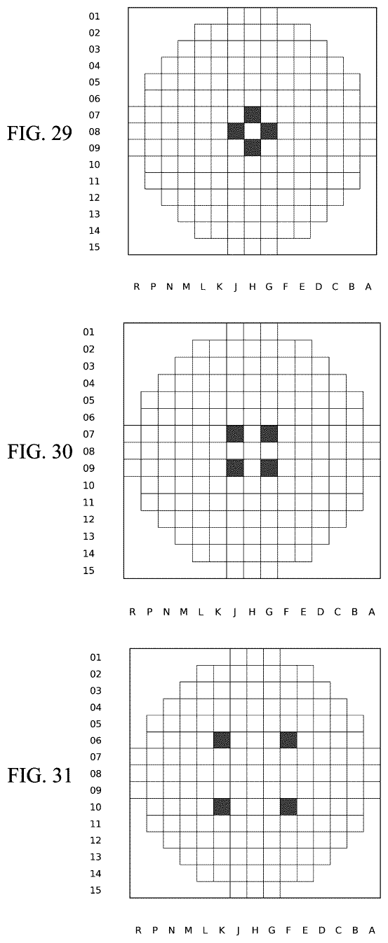

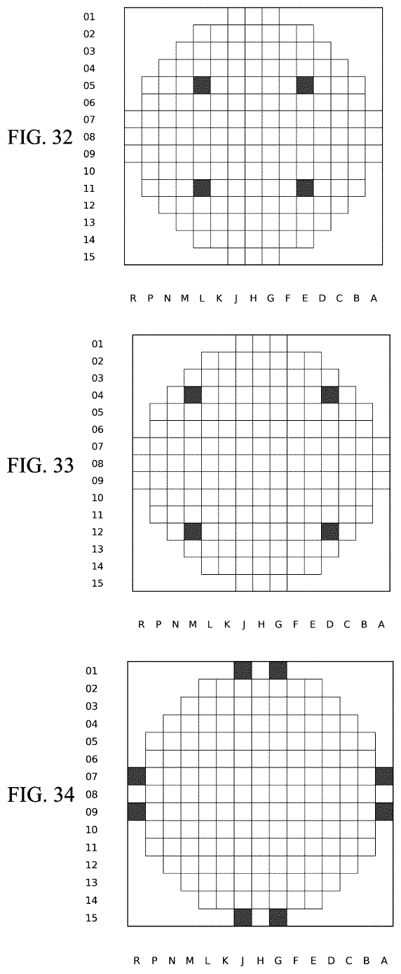

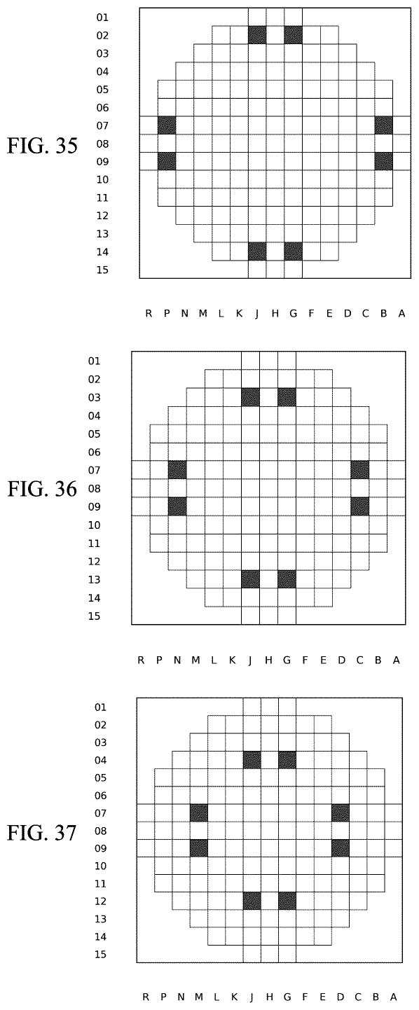

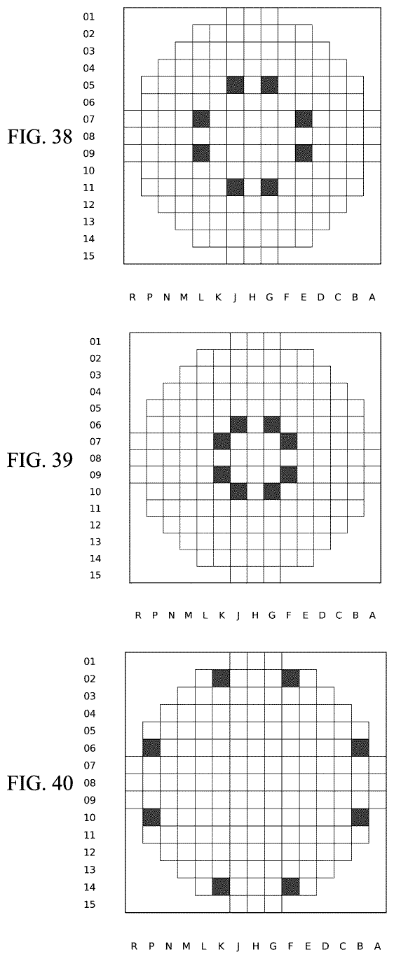

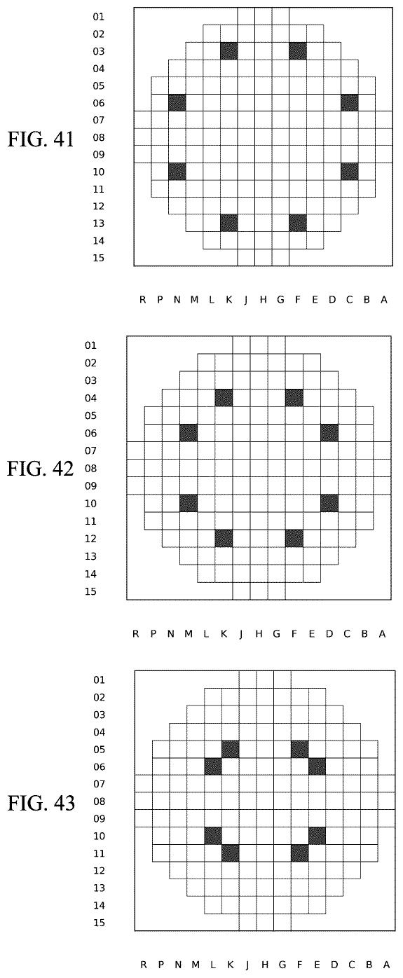

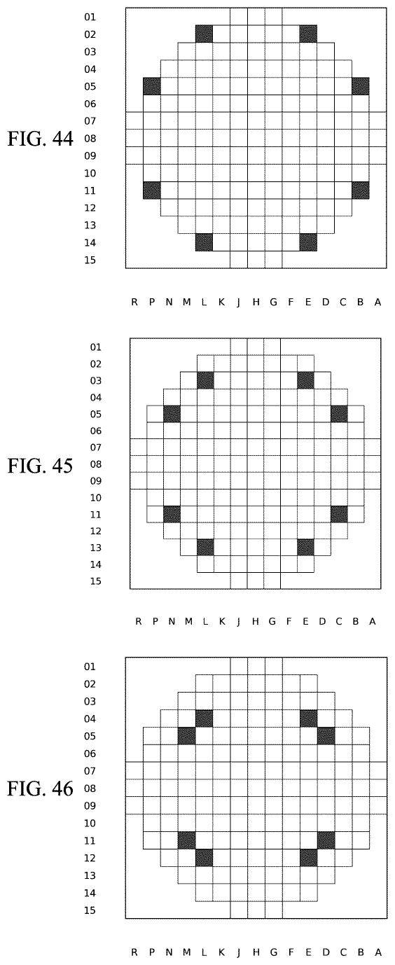

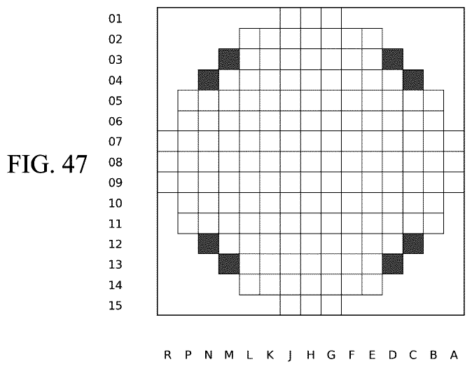

FIGS. 23 to 33 illustrate the 11 positions of symmetry 4, and FIGS. 34 to 47 illustrate the 14 positions of symmetry 8.

The fuel assemblies are therefore partitioned into 11 families 4, 14 families 8, and one family 1 containing only one assembly:
therefore: 4×11+8×14+1=157 assemblies.

Thus the pattern formed from these positions leads to a total of 157 assemblies.

There is of course a greater number of positions in a core comprising more than 157 assemblies, but always families 4, families 8, and family 1, in compliance with these positional symmetries.

The sequence of the calculation steps is described below.

The neutronics calculation code is launched and the parameters Margin(pattern), Fxy(pattern), and Fxy,g (pattern) are extracted from the results in order to evaluate criterion CPE defined above.

If criterion CPE has reached a target value of 0 or close to 0 during a maximum number of swaps achieved, then the pattern having this target value becomes the pattern selected for the future cycle.

During these swaps, positions are reassigned while remaining in compliance with symmetry 4 and symmetry 8 for each family 4 and family 8. Swaps of assembly positions are thus carried out, and after each or after several swaps, a new neutronics calculation is carried out in order to determine the new criterion CPE. This process continues and the core having a CPE of zero or close to zero may be selected as a candidate.

The swaps within families 4 and families 8 are described below.

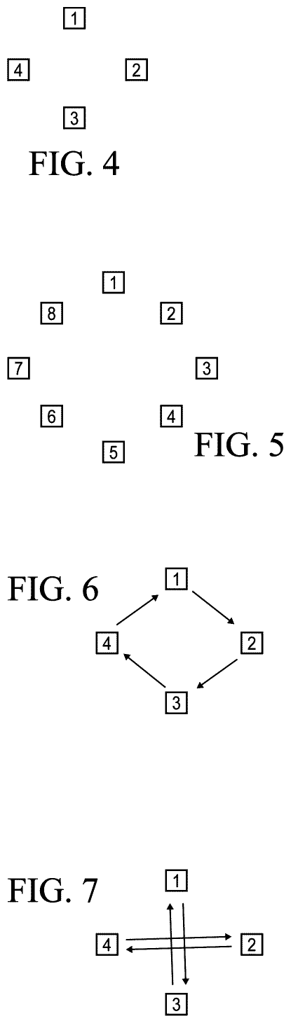

“Configuration of a family” refers to an order of placement of the assemblies of the family in the positions of the position of symmetry to which it is assigned. Each assembly position of a given symmetry family has a rank in accordance with FIG. 4 and FIG. 5.

Note that FIGS. 4 and 5 are not an image of the core as shown in FIG. 2, but a symbolic representation of positions in symmetry 4 or in symmetry 8 as defined above.

Because the four assemblies of a family 4 are placed in the four positions of a position of symmetry 4, it is possible to swap them according to one of the three possibilities described below.

During swap 4.a, the assembly located in position 4 is placed in position 1. The assembly located in position 1 is placed in position 2. The assembly located in position 2 is placed in position 3. The assembly located in position 3 is placed in position 4.

During swap 4.b, the assemblies change positions in the symmetric position, relative to the axes of symmetry on which they are located, as illustrated in FIG. 7.

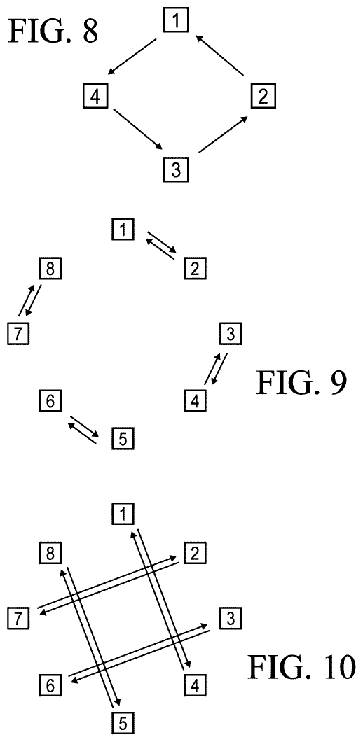

During swap 4.c, the assemblies change position by rotating in the opposite direction to swap 4.a, in accordance with FIG. 8.

We can therefore count four possible configurations for the four assemblies of a family 4 in the cells of a symmetric position 4 (the initial configuration plus the three obtained by the three swaps).

For families 8 and positions of symmetry 8, there are seven possible swaps, i.e. eight possible configurations (the initial configuration plus the seven configurations obtained by the seven swaps). These seven swaps are described below.

During swap 8.a (illustrated in FIG. 9), the assembly located in position 1 is placed in position 2. The assembly located in position 2 is placed in position 1. The assembly located in position 3 is placed in position 4. The assembly located in position 4 is placed in position 3. The assembly located in position 5 is placed in position 6. The assembly located in position 6 is placed in position 5. The assembly located in position 7 is placed in position 8. The assembly located in position 8 is placed in position 7.

During swap 8.b, the assemblies change position within the symmetric position, in accordance with FIG. 10.

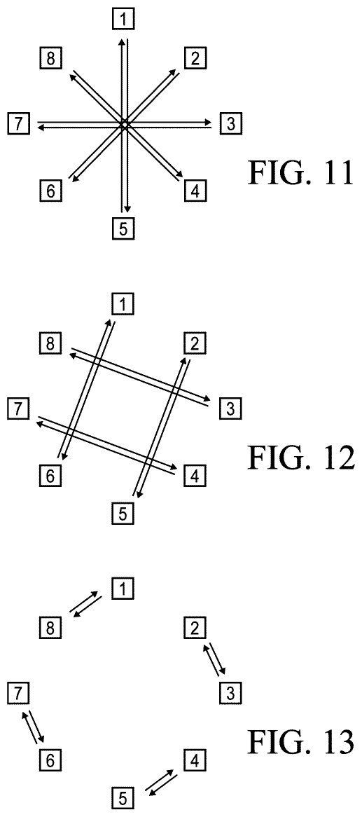

During swap 8.c, the assemblies change position within the symmetric position, in accordance with FIG. 11.

During swap 8.d, the assemblies change position within the symmetric position, in accordance with FIG. 12.

During swap 8.e, the assemblies change position within the symmetric position, in accordance with FIG. 13.

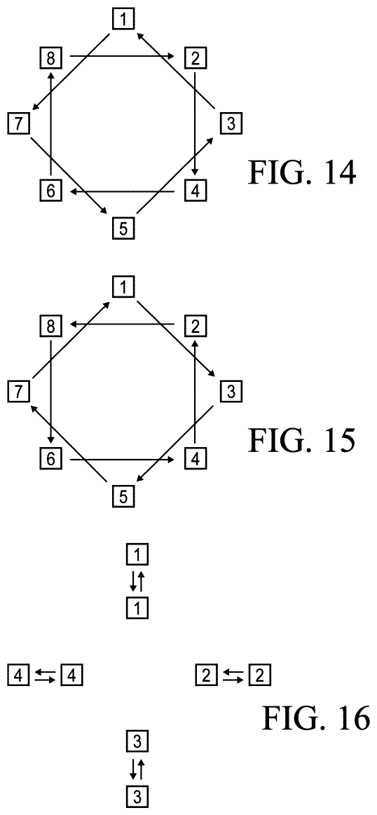

During swap 8.f, the assemblies change position within the symmetric position, in accordance with FIG. 14.

During swap 8.g, the assemblies change position within the symmetric position, in accordance with FIG. 15.

In the above, the swaps were carried out within a same family, therefore involving “intra-family” swaps.

However, one or more swaps may also be provided for between two families, one taking the place of the other. The configuration of a family is therefore changed by moving from one of the four configurations of a family 4 to another configuration of the same family 4, or by moving from one of the eight configurations of a family 8 to another configuration of the same family 8.

A swap of families 4 is defined as an exchange of two different families 4 located in two different symmetric positions 4 of the core pattern. The assemblies placed in position 1 of the two symmetric positions 4 exchange their positions. The assemblies placed in position 2 of the two symmetric positions 4 exchange their positions. The assemblies placed in position 3 of the two symmetric positions 4 exchange their positions. The assemblies placed in position 4 of the two symmetric positions 4 exchange their positions. This is illustrated in FIG. 16.

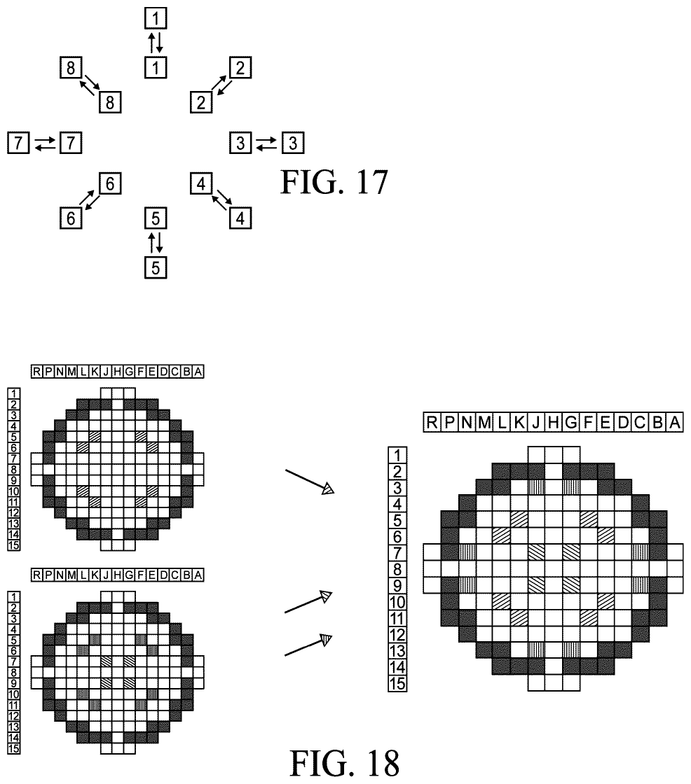

As for the families 8, a swap of families 8 is defined as an exchange of two different families 8 located in two different symmetric positions 8 of the core pattern. The assemblies placed in position 1 of the two symmetric positions 8 exchange their positions. The assemblies placed in position 2 of the two symmetric positions 8 exchange their positions. The assemblies placed in position 3 of the two symmetric positions 8 exchange their positions. The assemblies placed in position 4 of the two symmetric positions 8 exchange their positions. The assemblies placed in position 5 of the two symmetric positions 8 exchange their positions. The assemblies placed in position 6 of the two symmetric positions 8 exchange their positions. The assemblies placed in position 7 of the two symmetric positions 8 exchange their positions. The assemblies placed in position 8 of the two symmetric positions 8 exchange their positions. This is illustrated in FIG. 17.

We now define, with reference to FIG. 18, an intermixing of two core patterns by the construction of a “child” core pattern from two “parent” core patterns, as follows:
the parent pattern with the lowest CPE is parent 1,
the parent pattern with the highest CPE of the two parents is parent 2.

If the two parent patterns have the same CPE, a random selection of equal probability allows choosing parent pattern 1.

P₄ positions of symmetry 4 and P₈ positions of symmetry 8 are selected, by random selection of equal probability, among the 11 positions of symmetry 4 and the 14 positions of symmetry 8, where P₄ is between 1 and 11 and P₈ is between 1 and 14.

In practice, P₄ and P₈ are close to a third of the number of positions of symmetry 4 and 8 respectively.

We position in the child core pattern, at the 9 (P₄+P₈) positions of symmetry thus selected, the families of assemblies which are located in the corresponding positions of symmetry of the parent core pattern 1, each family remaining in the same configuration as in parent 1.

In parent core 2, the positions of symmetry 4 and the positions of symmetry 8 which were not selected in the previous step are traversed. If these positions of symmetry 4 and 8 contain families of assemblies 4 and 8 which have not yet been positioned in the child core pattern, then they are positioned in the corresponding positions of symmetry of the child core pattern, each family of assemblies then remaining in the same configuration as in parent core 2.

If unoccupied positions of symmetry 4 remain in the child core pattern, an equivalent number of families 4 not yet positioned in this child pattern also remain. In this case, a position of symmetry 4 among the remaining positions of symmetry 4, and a family 4 among the remaining families 4, are randomly (or pseudo-randomly depending on the rules if any) selected, and assemblies of this family 4 are placed in this position of symmetry 4, then the configuration is randomly selected among the four possible configurations. This process is repeated until all the remaining families 4 have been placed in a position of symmetry 4. If no random selection is necessary for example, then, at each step in this process, the position of symmetry 4 closest to the center of the core may be selected, as well as the family 4 having the lowest average burnup among the remaining families 4, the family remaining in the same configuration as in parent core 2, and this process is repeated until all the remaining families 4 have been placed in a position 4.

If unoccupied positions of symmetry 8 remain in the child core pattern, then an equivalent number of families 8 not yet positioned in this child pattern also remain. In this case, a random selection may be made of a position of symmetry 8 among the remaining symmetric positions 8, and of a family 8 among the remaining families 8, and the assemblies of this family 8 are placed in this symmetric position 8, then a random selection is made of the configuration among the eight possible configurations and this process is repeated until all the remaining families 8 have been placed in a position of symmetry 8. If no random selection is necessary, then, at each step in this process, the position of symmetry 8 closest to the center of the core may be selected, as well as the family 8 having the lowest average burnup among the remaining families 8, the family remaining in the same configuration as in parent core 2, and this process is repeated until all remaining families 8 have been placed in a symmetric position 8.

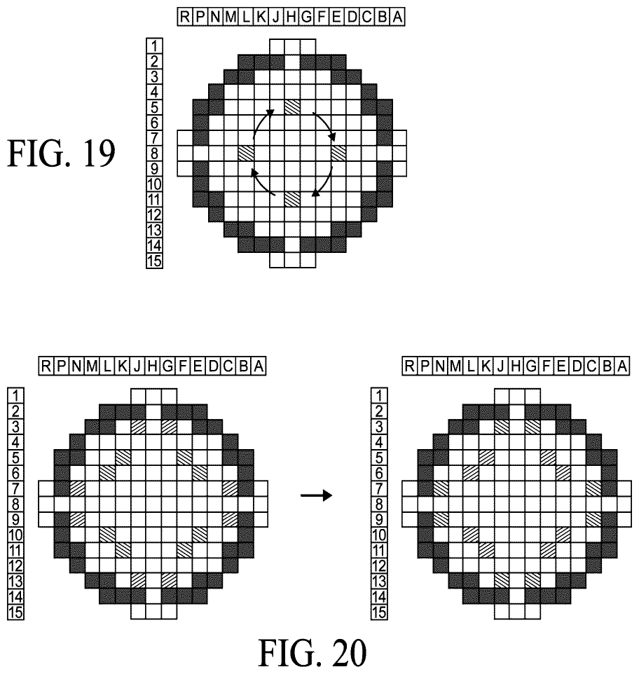

In summary, there are three types of assembly placement/swap:
placement by intermixing two core patterns, as illustrated in FIG. 18,
swap within a same family (rotation for example), as illustrated in FIG. 19,
swap between two families having the same number of members, as illustrated in FIG. 20.

With reference to FIG. 22, in order to test the different patterns thus obtained, (positive) integers K, K1, K2 are defined where K=K1+K2. K core patterns may be created from the initial core pattern obtained in step 2, according to the following operations carried out in any order, with reference to block S2 in FIG. 22 (which follows an initial step S1 during which one can observe the burnups of the assemblies to be placed for example).

K1 core patterns are created by inter-family swapping (i.e. within a same family), each of the patterns being created by application of P_{K1,8} (P_{K1,8} chosen among the integers 1, 2, . . . ) swaps of two families 8, and/or P_{K1,4} (P_{K1,4} chosen among the integers 1, 2 . . . ) swaps of two families 4.

P_{K1,8} and P_{K1,4} are set beforehand, for example by random selection from the set of integers from 1 to 10.

The P_{K1,8} pairs of families 8 and the P_{K1,4} pairs of families 4 are chosen by random selection of equal probability among the 14 families 8 and the 11 families 4.

FIG. 20 illustrates an example where P_{K1,8}=1.

Next, K2 core patterns are created by inter-family swapping. This is a swap in order to transition from one configuration to another for P_{K2,8} (P_{K2,8}=1, 2 . . . ) families 8 and/or a swap in order to transition from one configuration to another for P_{K2,4} (P_{K2,4} chosen among the integers 1, 2 . . . ) families 4. The P_{K2,8} families 8 and the P_{K2,4} families 4 are chosen by random selection among the 14 families 8 and the 11 families 4. The type of swap applied to each of these families is chosen by random selection of equal probability (one among eight possible configurations for families 8 and one among four possible configurations for families 4).

These K core patterns constitute the set of core patterns referred to here as “generation 0”.

Having predefined the (positive) integers C1, C2, C3 where K=C1+C2+C3, we then proceed with applying the following procedure N times (block S6 of FIG. 22), in order to construct the set of generation n core patterns based on the generation of core patterns of generation n−1 (n going from 1 to N).

The following three sub-steps refer to block S4 of FIG. 22.

We proceed with creating C1 core patterns in the following manner:
choosing, by random selection of equal probability, a core pattern among the set of K patterns from the previous step n−1, and
applying swaps of P_{C1,8} (P_{C1,8} selected among integers 1, 2 . . . ) pairs of families 8 and/or of P_{C1,4} (P_{C1,4} selected among integers 1, 2 . . . ) pairs of families 4.

We then proceed with creating C2 core patterns in the following manner:
choosing, by random selection of equal probability, a core pattern among the set of remaining K core patterns from step n−1, and
applying swaps of P_{C2,8} (P_{C2,8} selected among integers 1, 2 . . . ) pairs of families 8 and P_{C2,4} (P_{C2,4} selected among integers 1, 2 . . . ) pairs of families 4.

Finally, we proceed with creating C3 core patterns by intermixing two core patterns among the K patterns from step n−1. The pair of core patterns is chosen by random selection of equal probability among the core patterns in the set of K patterns from step n−1.

Referring again to FIG. 22, in the pattern evaluation step S3, we proceed with determining the evaluation according to criterion CPE presented above, for the K core patterns from the previous step n−1 and for the K patterns created in step n as explained above.

In step S5, K patterns having the smallest CPE evaluation are selected among these 2×K patterns. These K selected patterns constitute the core patterns of step n.

These N applications of the above procedure are repeated i times (block S7), modifying the parameters P_{C1,8}, P_{C1,4}, P_{C2,8}, P_{C2,4} . . . .

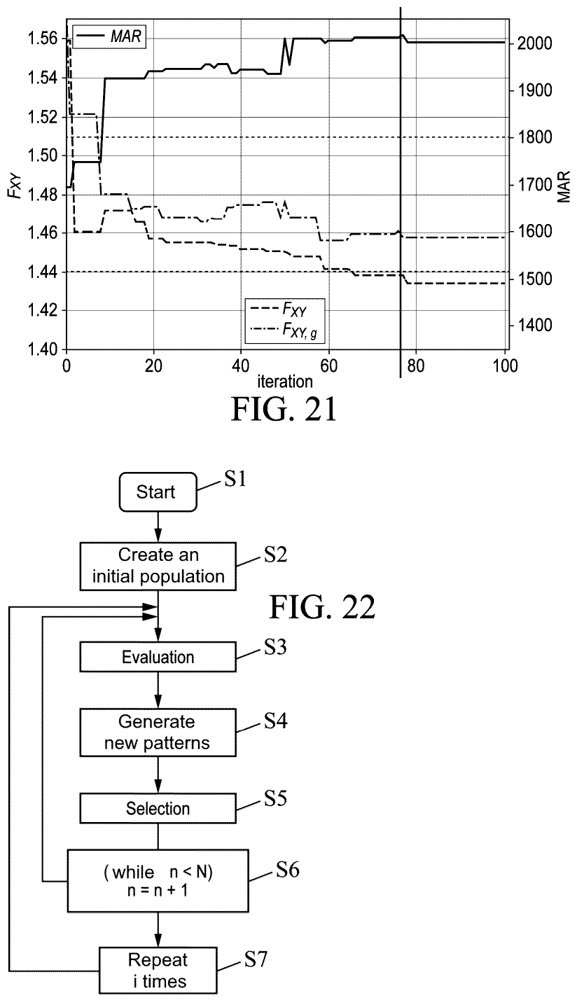

We obtain a result similar to the one presented in FIG. 21 illustrating an example of the evolution of criteria Fxy, Fxy,g and MAR over 100 generations.

The method then allows obtaining patterns optimized for Fxy (hot spot factor), Fxy,g (hot spot factor in the presence of clusters), and MAR (shutdown margin), thus best satisfying the simultaneous consideration of these three criteria. We note here that beginning with generation 65, we have at least one pattern which has reached the minimum CPE, therefore satisfying all of these criteria. One may note that typically in generation 67 for example, there is a reduction in the hot spot factors (as expected for a “good” core), at the expense of a very slight drop in the shutdown margin but which remains within an acceptable range. Such an observation clearly shows that a convergence is desired towards a compromise between these three criteria at the same time, and not on each of these criteria successively as a person skilled in the art would typically think.

Such an implementation makes it possible to select patterns randomly, their intermixing with other patterns or their swaps leading to patterns of unexpected quality for a person skilled in the art, sometimes in a counterintuitive manner. The random generation thus automated, then tested, allows the creation of quality patterns which converge rapidly (a few tens of minutes at most) towards meeting criterion CPE.

The method in the meaning of this disclosure allows testing several reloading strategies for an actual cycle or for a series of cycles until equilibrium is reached in terms of compromise between several criteria, and does so without mobilizing human resources. In particular, cycles that must include test assemblies which fall outside a standard nomenclature and are technologically novel, are no longer a difficulty.

On average, the gain in human resources mobilization time per loading pattern is thus on the order of four days.

Of course, this disclosure is not limited to the description of the exemplary embodiments presented above by way of example, but extends to other variants.

We have described above the attainment of a compromise for a core of 157 assemblies. However, the above principles may of course be applied to other types of core, distinguished here by the size of the core and therefore by the number of assemblies. Thus the number of families 4 and families 8 increases. The principles set forth in terms of allowed swaps and more generally in the flowchart in FIG. 22 are retained.

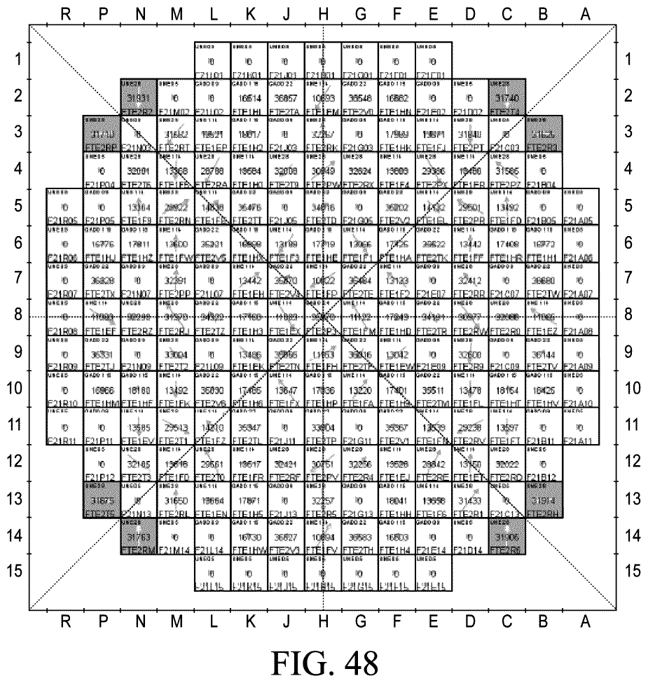

We have also illustrated in FIG. 48 a core of 193 assemblies, having a central position and 192 positions which are distributed as follows:
12 families of 4 assemblies,
and 18 families of 8 assemblies (with 48+144+1=193).

Here again, one can assess the similar burnups by family of assemblies (for example 31875 MWd/t and 31763 MWd/t at P13 and N14).

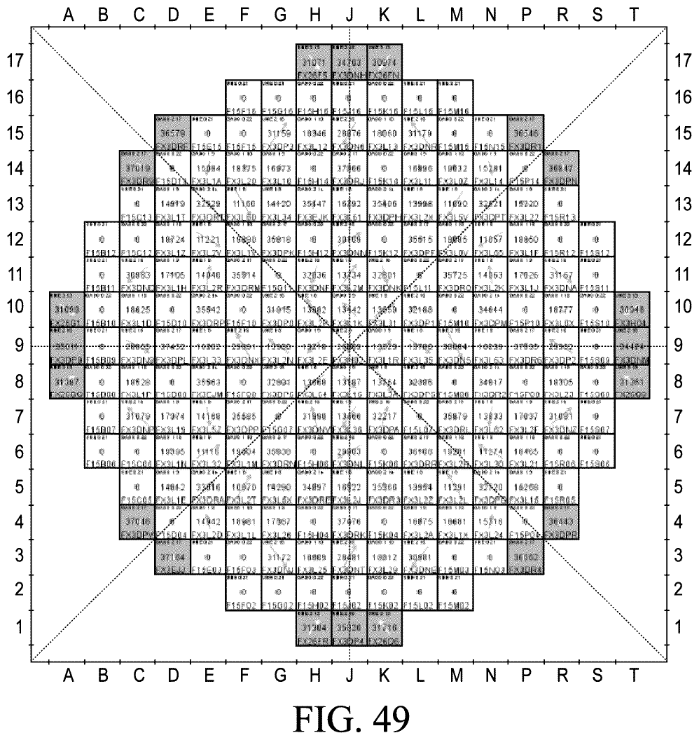

The core of FIG. 49, with 205 assemblies, has a central position and 204 positions which are distributed as follows:
13 families of 4 assemblies,
and 19 families of 8 assemblies (13×4+19×8+1=205).

These principles also apply to cores having different assembly shapes, for example and in a non-limiting manner, a hexagonal, triangular, or rectangular cross-section instead of a square cross-section as presented above. In this case, the axes of symmetry are different and the numbers of families differ, but the same principles as set forth above can remain.

Furthermore, a criterion CPE was presented above in the form of a sum of three terms to take into account three parameters. Of course, other parameters may be taken into account, thus possibly increasing the number of terms in the aforementioned sum.

Furthermore, a grouping of assemblies by families, essentially according to their respective burnup values, was presented above. As indicated in the above description, other parameters apart from burnup may be used to form the families (assembly technology, type of fuel, etc.).

1-17. (canceled)

18. A method, assisted by computer means, for determining an optimal core-loading pattern for a nuclear reactor core, wherein respective positions of nuclear fuel assemblies are tested by said computer means according to at least one criterion before assigning optimal positions to the assemblies and proceeding with loading the reactor, the reactor core comprising a multiplicity of cells positioned symmetrically relative to a plurality of axes of symmetry, with standard assemblies each intended for insertion into a cell, standard assemblies for future loading being distributed into to at least three categories, defined by the number of production cycles of the nuclear reactor:
a first category of assemblies which have not been used in a previous production cycle and which have a burnup below a first threshold,
a second category of assemblies which have been used in a previous production cycle and which have a burnup between the first threshold and a second threshold that is greater than the first threshold, and
a third category of assemblies which have been used in at least two previous production cycles and which have a burnup above the second threshold,
the method comprising the following steps:
identifying groups of cell positions which are symmetric relative to said axes of symmetry, and counting a number of symmetric positions in each group,
forming families of standard assemblies, the standard assemblies of a same family having at least similar burnups, and said families each comprising a number of standard assemblies respectively corresponding to a number of positions in one of said groups,
choosing, from a database of valid template loading patterns, a template loading pattern for which the assembly burnups, by family, are closest to the burnups of the standard assemblies, by family, and, within the context of a numerical simulation, assigning to the standard assemblies respective initial positions corresponding to the positions of the assemblies in the chosen template pattern,
testing, by numerical simulation, the loading pattern composed of the standard assemblies at said initial positions, in relation to at least one predetermined criterion,
swapping positions of standard assemblies while retaining the previously formed families of assemblies, and testing, by numerical simulation, the loading pattern formed of the standard assemblies at said swapped positions, in relation to said predetermined criterion, and
repeating the swapping and testing step until at least one candidate pattern for loading the reactor is obtained, the candidate pattern being the one which best satisfies said predetermined criterion.

19. The method according to claim 18, wherein the swaps are carried out randomly, while in accordance with predetermined rules.

20. The method according to claim 18, wherein which said plurality of axes of symmetry comprises four axes of symmetry of the core, which pass through the center of the core and comprise two axes, one vertical and the other horizontal, and two axes having a respective slope of 45 degrees and 135 degrees relative to a horizontal line,
and wherein groups of N positions of cells located on said axes of symmetry and groups of M positions of cells not located on said axes of symmetry are considered.

21. The method according to claim 18, comprising, in the context of said numerical simulation:
placing an assembly, chosen among said standard assemblies, in a central position, and
placing the assemblies of said families around the central assembly, in groups of positions which are symmetric relative to the plurality of axes of symmetry, the assemblies positioned in a same group of positions being members of a same family of standard assemblies.

22. The method according to claim 18, wherein the swaps within a same family modify each assembly position of the family.

23. The method according to claim 18, comprising, in order to test swaps between families:
swapping the positions of standard assemblies between two different families having the same number of members, and testing, by numerical simulation, the loading pattern composed of the standard assemblies at said swapped positions, in relation to said predetermined criterion.

24. The method according to claim 18, wherein the swapping and testing step is:
carried out in a predetermined number of iterations, until a first candidate pattern is identified, then
repeated for a predetermined number of iterations, until a second candidate pattern is identified,
the method further comprising at least one step of testing an intermixed pattern that combines the first and second patterns.

25. The method according to claim 24, comprising the construction of an intermixed pattern in which the positions of a subset of the families of assemblies of the first candidate pattern are kept, and the remaining families of assemblies are:
assigned to positions which coincide with the positions of these same families in the second pattern, if these positions are still available in the intermixed pattern, or
assigned to other groups of available positions, the number of members of said other groups being equal to the number of family members that remain to be placed.

26. The method according to claim 18, wherein the assemblies include a face which is facing a predetermined observation point, and after swapping, the swapped assemblies still have this face facing the observation point.

27. The method according to claim 18, wherein a numerical simulation is carried out by neutronics calculations for each core pattern tested, under conditions with and without insertion of control rod clusters to quench the nuclear fission reaction, in order to estimate values specific to the core pattern tested, said values comprising hot spot factors without clusters Fxy(pattern) and with clusters Fxy,g(pattern), as well as a shutdown margin Margin(pattern).

28. The method according to claim 27, wherein said estimated quantities are compared to limit values in the calculation of a core-loading pattern evaluation expression, denoted CPE, and a candidate pattern is selected, among the possible patterns, which has the smallest evaluation expression CPE, thus satisfying said predetermined criterion.

29. The method according to claim 28, wherein the evaluation expression CPE of a pattern is given by:
$$EPC = C \times max ( {Margin}_{lim} - Margin ( pattern ) ; 0 ) \text{} + ( \frac{{Margin}_{lim}}{{Fxy}_{lim}} ) \times max ( Fxy ( pattern ) - {Fxy}_{lim} ; 0 ) + {Margin}_{lim} \times {\sum }_{g} ( \frac{1}{{Fxy}_{lim} , g} \times max ( Fxy , g ( pattern ) - {Fxy}_{lim} , g ; 0 ) )$$
where:
Marginₗᵢₘ is a shutdown margin limit value,
Fxyₗᵢₘ,g is a hotspot limit value in the presence of control rod clusters,
Fxyₗᵢₘ is a hotspot limit value in the absence of control rod clusters,
C is a positive real coefficient, and
Σ_{g} represents the sum over the set of control rod clusters of the given expression for a cluster g:
$$( \frac{1}{{Fxy}_{lim} , g} \times max ( Fxy , g ( pattern ) - {Fxy}_{lim} , g ; 0 ) ) .$$

30. The method according to claim 29, wherein, in the evaluation expression CPE, the terms:
$$( \frac{{Margin}_{lim}}{{Fxy}_{lim}} ) \times max ( Fxy ( pattern ) - {Fxy}_{lim} ; 0 )$$
$$and$$
$${Margin}_{lim} \times {\sum }_{g} ( \frac{1}{{Fxy}_{lim} , g} \times max ( Fry , g ( pattern ) - {Fxy}_{lim} , g ; 0 ) )$$
are of the same order of magnitude,
and the coefficient C is chosen so that the term C×max(Marginₗᵢₘ−Margin(pattern);0) is also of the same order of magnitude as one of the two aforementioned terms.

31. The method according to claim 29, wherein the coefficient C is between 0.5 and 1.

32. The method according to claim 29, wherein the coefficient C is between 1 and 10.

33. A non-transitory computer storage, storing instructions of a computer program causing the implementation of the method according to claim 18, when said instructions are executed by a processor of a processing circuit.

34. A computing device comprising a processing circuit for implementing the method according to claim 18.
